(19) United States
(12) Patent Application Publication
(10) Pub. No.: US 2011/0185830 A1
(43) Pub. Date: Aug. 4, 2011

(54) ANDERSON GYRO STABLE SYSTEM FOR REMOTE CONTROL TWO-WHEEL MODEL

(75) Inventor: Han-Chuen CHEN, Taichung City (TW)

(73) Assignee: ANDERSON MODEL CO., LTD., Taichung City (TW)

(21) Appl. No.: 12/873,726

(22) Filed: Sep. 1, 2010

(30) Foreign Application Priority Data
Feb. 2, 2010 (TW) 99103084

(51) Int. Cl. B62D 37/06

(52) U.S. Cl. 74/5.22

(57) ABSTRACT

An AGSS for an RC two-wheel model composed of a wheel body, a wheel frame received in the wheel body, a spindle inserted through the wheel frame, a transmission gear assembly mounted to the spindle, a flywheel assembly mounted to the spindle, and a unidirectional rotary assembly. The unidirectional rotary assembly includes a sleeve rotatably sleeved onto the spindle, and a unidirectional rotary member mounted to the sleeve. The sleeve has external annular teeth engaging the transmission gear assembly. The unidirectional rotary member is mounted in the flywheel assembly for driving unidirectional rotation of the flywheel assembly as the RC two-wheel model gets started and for disengaging from the flywheel assembly as the RC two-wheel model brakes, such that the flywheel idles to protect the internal parts of the RC two-wheel model from inertial collision.

### BACKGROUND OF THE INVENTION

1. Field of the Invention

The present invention relates generally to a remote control (RC) two-wheel model, and more particularly, to an Anderson gyro stable system (AGSS) for an RC two-wheel model.

2. Description of the Related Art

When a conventional RC two-wheel model, like motorcycle, is running in high speed, its clutch assembly of the rear wheel expands outward due to the centrifugal effect to contact the flywheel assembly for driving high-speed rotation of the flywheel in such a way that the flywheel assembly in high-speed rotation results in gyroscopic effect to enhance the stability of the running RC two-wheel model.

However, when the RC two-wheel model starts to run, the rear wheel is of low rotary speed, such that the clutch assembly fails to expand outward due to insufficient centrifugal force and no contact is made between the clutch assembly and the flywheel assembly, thus disabling any gyroscopic effect, where the gyroscopic effect can only happen due to the contact between the clutch assembly and the flywheel while the rotation of the rear wheel reaches more than 800 rpm. Thus, the conventional RC two-wheel model having the clutch assembly is easily lack of stability while starting to run.

When the RC two-wheel model running in high speed brakes, the clutch assembly fails to immediately react to the decreasing rotary speed of the rear wheel to disengage from the flywheel after temporary delay for seconds, such that other parts inside the rear wheel are subject to damage due to the inertial collisions resulting from the delayed disengagement of the clutch assembly over a long period of time.

In light of the above, how to stabilize the RC two-wheel model as it starts to run and protecting its internal parts for longer working lives as it runs in high speed and then brakes become urgent problems in need of solutions.

### SUMMARY OF THE INVENTION

The primary objective of the present invention is to provide an AGSS for an RC two-wheel model, wherein the AGSS can allow the RC two-wheel model to have good stability as it starts to run and protect its internal parts for longer working lives as it runs in high speed and brakes.

The foregoing objective of the present invention is attained by the AGSS composed of a wheel body, a wheel frame, a spindle, a transmission gear assembly, a flywheel assembly, and a unidirectional rotary assembly. The wheel frame is mounted in the wheel body and includes internal annular teeth. The spindle is rotatably mounted to a center of the wheel frame. The transmission gear assembly is sleeved onto the spindle and engages the internal annular teeth. The flywheel assembly includes an axial hole and is sleeved onto the flywheel assembly via the axial hole for free rotation on the spindle. The unidirectional rotary assembly includes a sleeve rotatably sleeved onto the spindle, and a unidirectional rotary member mounted to the sleeve. The sleeve has external annular teeth engaging the transmission gear assembly. The unidirectional rotary member is mounted in the axial hole of the flywheel assembly.

When the unidirectional rotary assembly is driven by the transmission gear assembly to start to rotate, the flywheel assembly can be driven for unidirectional rotation at the same time to enhance the stability of the RC two-wheel model as the AGSS runs in low rotary speed. When the rotary speed of the unidirectional rotary assembly is lower than that of the flywheel assembly, the unidirectional rotary assembly can disengage from the flywheel assembly to enable the flywheel assembly to idle in such a way that the aforesaid inertial collision resulting from the delayed disengagement can be avoided to protect the internal parts of the AGSS.

### BRIEF DESCRIPTION OF THE DRAWINGS

FIG. 1 is a perspective view of a first preferred embodiment of the present invention.

FIG. 2 is an exploded view of the first preferred embodiment of the present invention.

FIG. 3 is a sectional view of the first preferred embodiment of the present invention.

FIG. 4 is a schematic view of the first preferred embodiment of the present invention, illustrating that the transmission gear assembly engages the internal annular teeth of the wheel frame.

FIG. 5 is another schematic view of the first preferred embodiment of the present invention, illustrating the unidirectional rotary member is installed in the axial hole of the flywheel assembly.

FIG. 6 is a schematic view of a part of the first preferred embodiment of the present invention, illustrating that one of the pawls of the unidirectional rotary member is inserted into one of the dentations of the flywheel assembly when the unidirectional rotary member runs in low rotary speed.

FIG. 7 is similar to FIG. 6, illustrating that the two pawls of the unidirectional rotary member are inserted into the two dentations of the flywheel assembly respectively when the unidirectional rotary member runs in high rotary speed.

FIG. 8 is similar to FIG. 6, illustrating the two pawls of the unidirectional rotary member depart from the two dentations of the flywheel assembly respectively when the unidirectional rotary member runs in low rotary speed.

FIG. 9 is an exploded view of a second preferred embodiment of the present invention.

FIG. 10 is a sectional view of the second preferred embodiment of the present invention.

FIG. 11 is a schematic view of a part of the second preferred embodiment of the present invention, illustrating that the unidirectional rotary member is installed in the axial hole of the flywheel assembly.

### DETAILED DESCRIPTION OF PREFERRED EMBODIMENTS

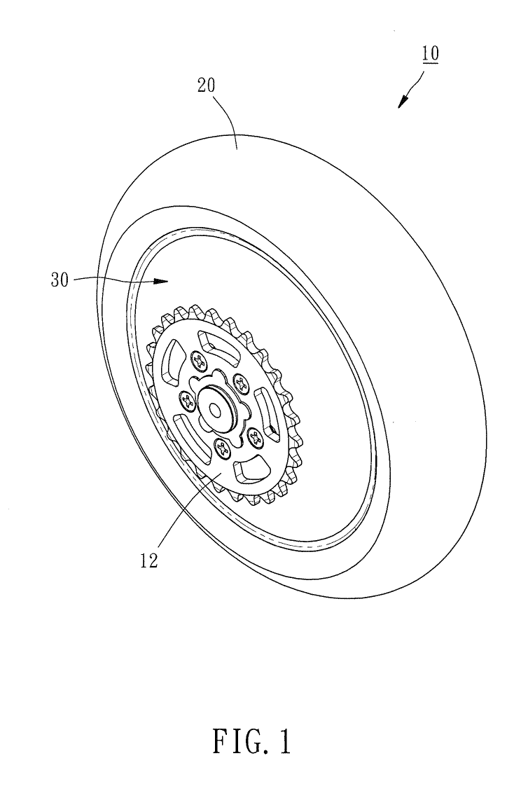

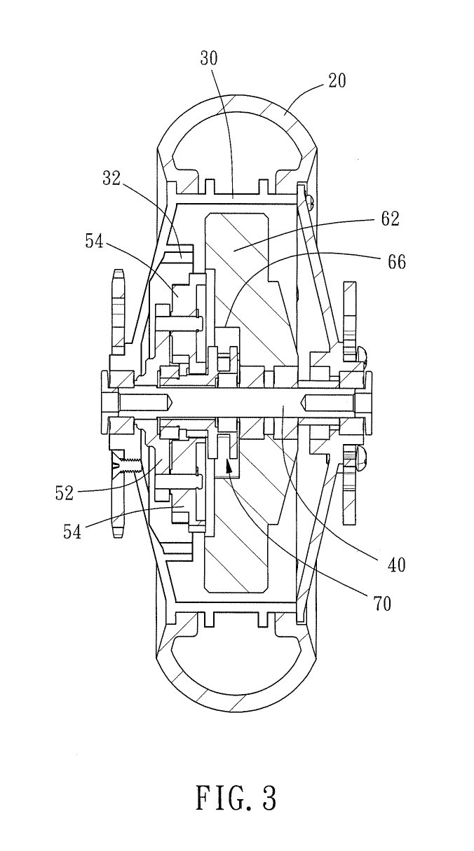

Referring to FIGS. 1-3, an AGSS 10 for an RC two-wheel model, like a motorcycle, in accordance with a first preferred embodiment of the present invention is composed of a wheel body 20, a wheel frame 30, a spindle 40, a transmission gear assembly 50, a flywheel assembly 60, and a unidirectional rotary assembly 70.

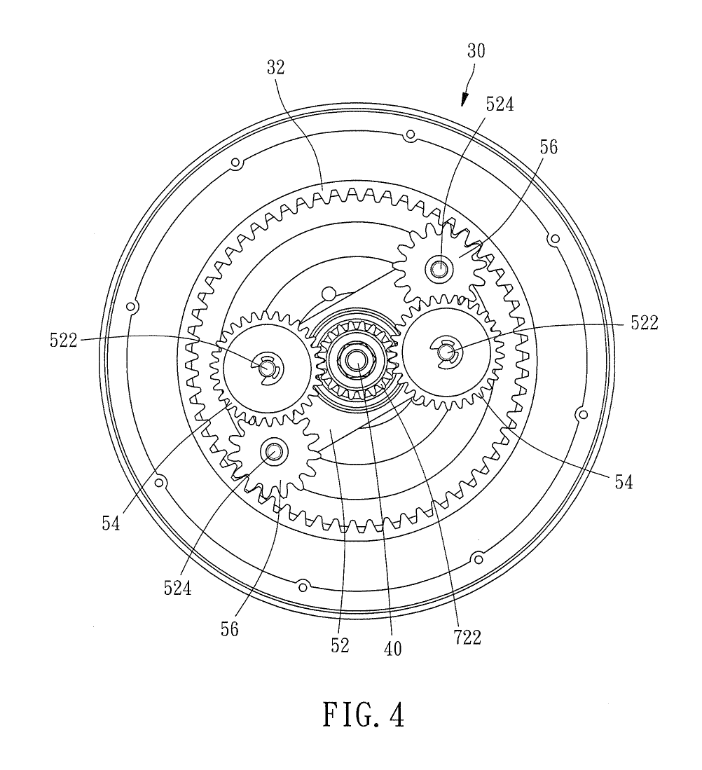

The wheel frame 30 is installed in the wheel body 20 and includes internal annular teeth 32 formed at an internal periphery thereof, as shown in FIG. 4, and a chain disk 12 connected with an external side thereof for a chain (not shown) to engage. When the chain disk 12 is rotated, the wheel body 20 can be driven by the chain for linking-up rotation.

The spindle 40 is rotatably connected with a center of the wheel frame 30 without rotation along with the wheel frame 30.

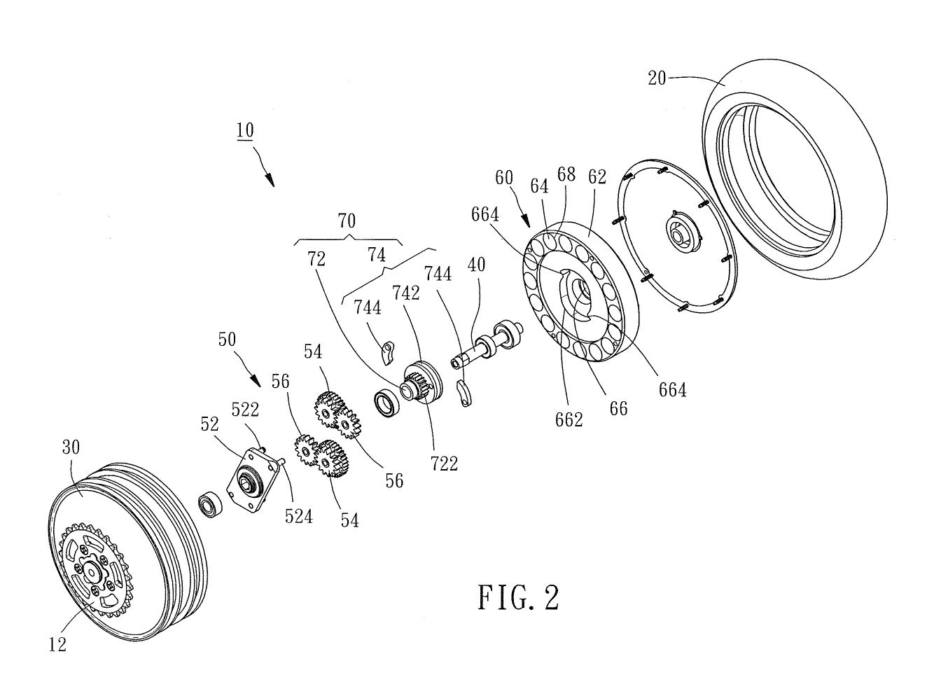

Referring to FIG. 2 again in view of FIG. 4, the transmission gear assembly 50 includes a base member 52, two first transmission gears 54, and two second transmission gears 56. The base member 52 is connected with the spindle 40 and has two first round rods 522 and two second round rods 524. Each of the first transmission gears 54 is rotatably mounted to one of the first round rods 522. Each of the second transmission gears 56 is rotatably mounted to one of the second round rods 524 and engages the internal annular teeth 32 and one of the first transmission gears 54. When the wheel frame 30 is rotated, the internal annular teeth 32 can drive the two second transmission gears 56 to rotate and then the two second transmission gears 56 drives the two first transmission gears 54 to rotate.

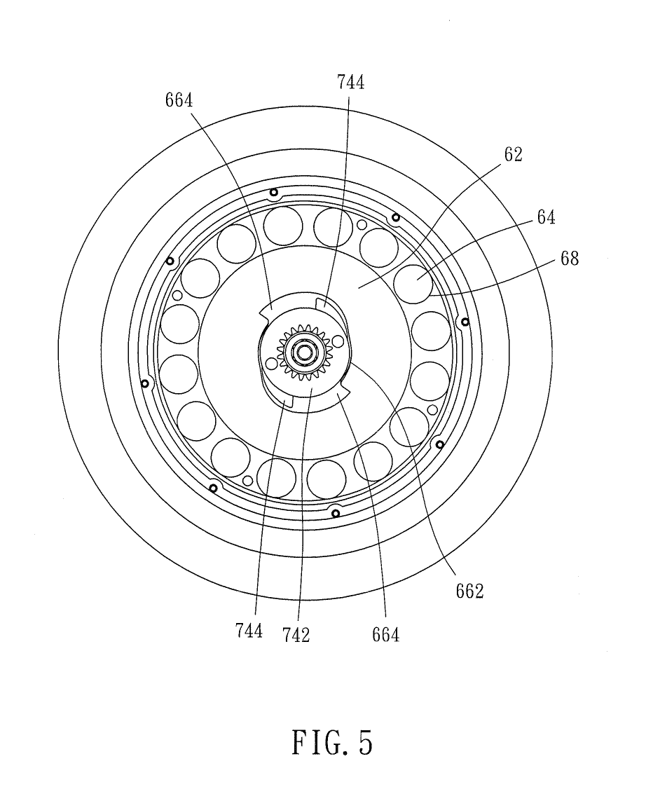

Referring to FIGS. 2 and 5, the flywheel assembly 60 includes a flywheel 62 and a plurality of weight pieces 64. The flywheel 62 has an axial hole 66 and a plurality of cavities 68. The axial hole 66 runs through a center of the flywheel 62 for inserting the spindle 40 in such a way that the flywheel assembly 60 can be sleeved onto the spindle 40 for free rotation on the spindle 40. A recession 662 and two opposite dentations 664 are formed on one side of the axial hole 66. The two dentations 664 are recessed downward from the wall of the recession 662. The cavities 68 are annularly arranged at a peripheral edge of the flywheel 62, surrounding the axial hole 66 as a center thereof. The weight pieces 64 are put into the cavities 68 respectively and can be selectively adjusted in number and arrangement as per the actual need; no more recitation is necessary because it belongs to the prior art.

Referring to FIGS. 2, 4 & 5 again, the unidirectional rotary assembly 70 includes a sleeve 72 and a unidirectional rotary member 74. The sleeve 72 is rotatably sleeved onto the spindle 40, having external annular teeth 722 for engaging the first transmission gears 54 in such a way that the sleeve 72 can be driven by the transmission gear assembly 50 for linking-up rotation. The unidirectional rotary member 74 is a ratchet wheel in this embodiment and received in the recession 662, having a ratchet disk 742 and two pawls 744. The ratchet disk 742 is connected with the sleeve 72 in one piece to allow the unidirectional rotary assembly 70 to be rotated together with the sleeve 72. The two pawls 744 are pivoted to the ratchet disk 742 and each can be inserted into one of the dentations 664 for driving rotation of the flywheel assembly 60. It is to be noted that the number of the pawl 744 is not limited to two as long as they can be equably arranged at the peripheral edge of the ratchet disk 742.

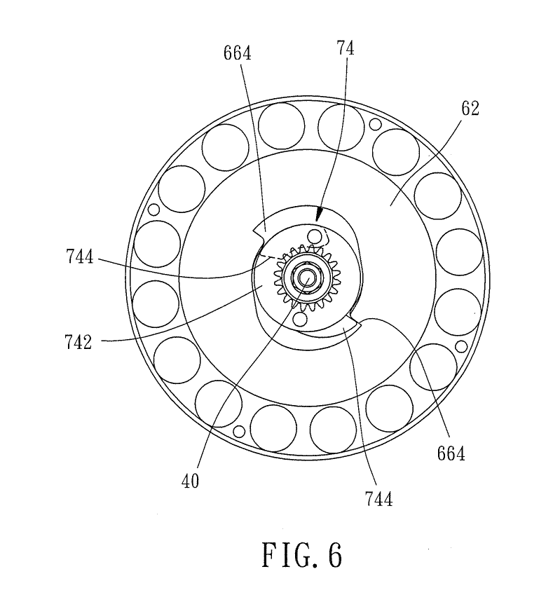

When the wheel body 20 is rotated along with the wheel frame 30, the unidirectional rotary member 74 can be driven by the external annular teeth 722 through the first transmission gear 54, the second transmission gear 56, and the internal annular teeth 32 in turn for rotation. When one of the pawls 744 pivots to be located above the spindle 40 and forced by the gravity to be embedded into the ratchet disk 742 rather than into one of the cavities 664. In the meantime, the other pawl 744 pivots to be located below the spindle 40 and likewise forced by the gravity to protrude outward and to be inserted into the other cavity 664, such that the flywheel assembly 60 can be driven by the unidirectional rotary member 74 for linking-up rotation while the AGSS 10 runs in low rotary speed, as shown in FIG. 6.

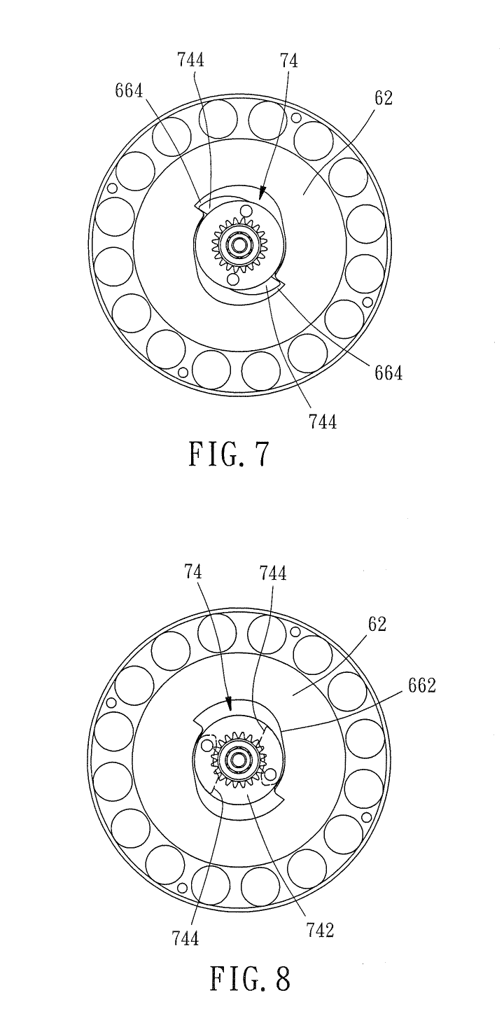

When the AGSS 10 is accelerated up to high speed, as shown in FIG. 6, the two pawls 744 of the unidirectional rotary member 74 are forced by the centrifugal force to project outward and then inserted into the two cavities 664 respectively to drive the flywheel to run in high speed in such a way that the gyroscopic effect is generated to provide stability for the RC two-wheel model, as shown in FIG. 7.

When the RC two-wheel model brakes, the rotary speed of the unidirectional rotary assembly 70 goes decreasingly to be lower than that of the flywheel assembly 60. In the meantime, the flywheel 62 has the wall of its recession 662 squeeze and push the two pawls 744 into the ratchet disk 742, as shown in FIG. 8, to keep he unidirectional rotary assembly 70 idling while the rotary speed of the unidirectional rotary assembly 70 is decreased, thus effectively avoiding the inertial collision resulting from the delayed disengagement and definitely prolonging the working life of the AGSS 10.

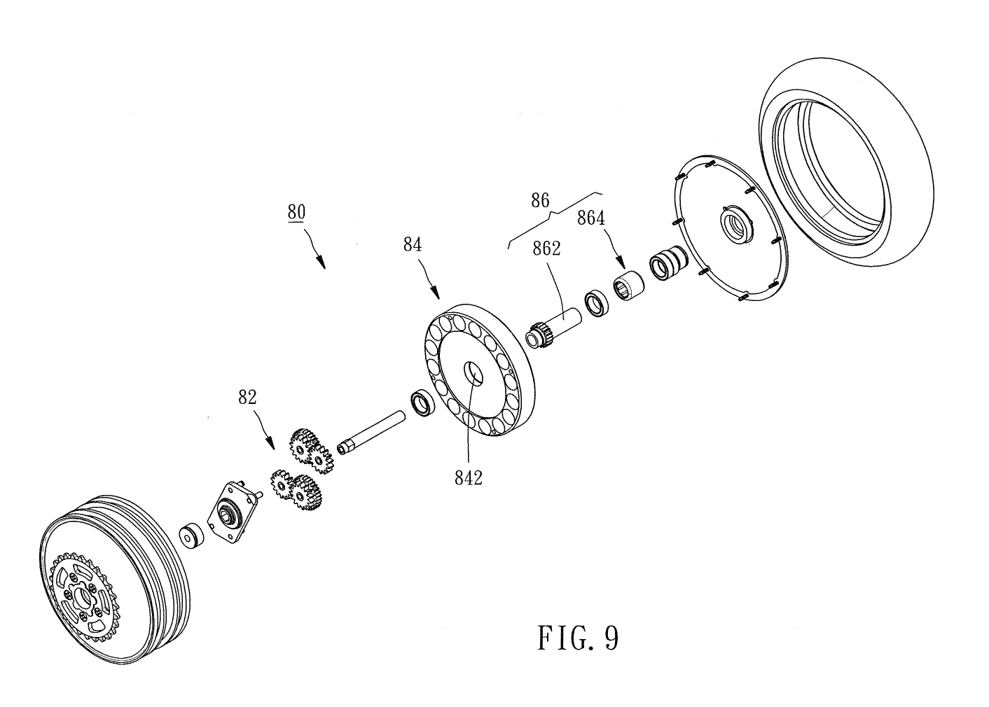

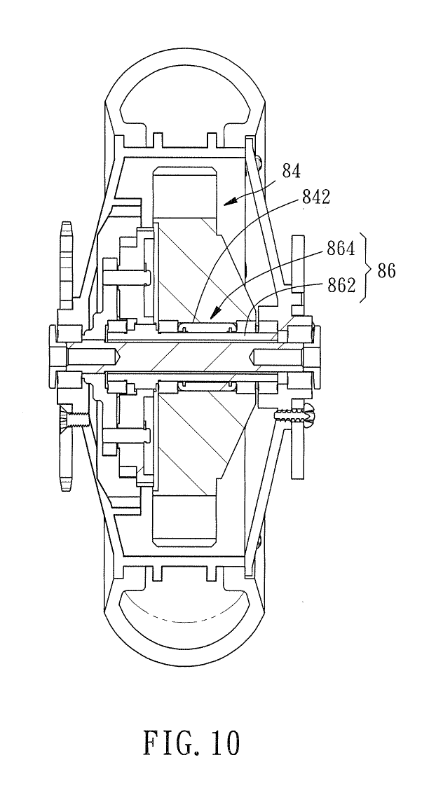

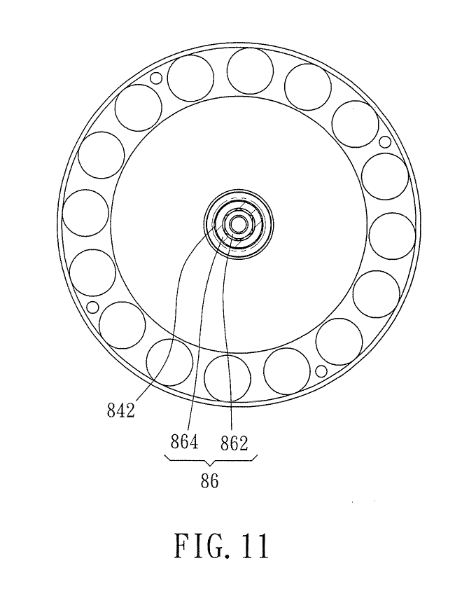

Referring to FIGS. 9-11, an AGSS 80 for an RC two-wheel model in accordance with a second preferred embodiment is structurally similar to that of the first embodiment, having the differences recited in the following paragraphs. When the RC two-wheel model starts to run, the AGSS 80 is of the low rotary speed and the sleeve 862 is driven by the transmission gear assembly 82 to synchronically drive the unidirectional rotary member 864 to rotate to further drive the wheel assembly 84 to rotate.

When the RC two-wheel model runs in high speed, the unidirectional rotary assembly 86 can still keep driving the flywheel assembly 84 to rotate in high speed for the gyroscopic effect of high-speed rotation, such that the running RC two-wheel model can keep stable.

When the RC two-wheel model is decelerated, the rotary speed of the sleeve 862 goes decreasingly to be lower than that of the flywheel assembly 84 and sleeve 862 can disengage from the unidirectional rotary member 864, such that unidirectional rotary member 864 runs around the sleeve 862 in high speed for idling to avoid the inertial collision.

In conclusion, the AGSS of the present invention allows the flywheel assembly to rotate, while the RC two-wheel model runs in low rotary speed, so as to provide good stability for the RC two-wheel model and to effectively get rid of the inertial collision applied to its internal parts while the RC two-wheel model is decelerated, thus prolonging the service life of the RC two-wheel model.

Although the present invention has been described with respect to specific preferred embodiments thereof, it is in no way limited to the specifics of the illustrated structures but changes and modifications may be made within the scope of the appended claims.

What is claimed is:

1. An AGSS for an RC remote two-wheel model, comprising:
a wheel body;
a wheel frame received in the wheel body and having internal annular teeth;
a spindle rotatably mounted to a center of the wheel frame;
a transmission gear assembly sleeved onto the spindle and engaging the internal annular teeth a flywheel assembly having an axial hole to be rotatably sleeved onto the spindle; and
a unidirectional rotary assembly having a sleeve rotatably sleeved onto the spindle and a unidirectional rotary member mounted to the sleeve, the sleeve having external annular teeth engaging the transmission gear assembly, the unidirectional rotary member being received in the axial hole; when the unidirectional rotary assembly is motionless, the unidirectional rotary member is combined with the flywheel assembly in such a way that the flywheel assembly can be driven by the unidirectional rotary member for unidirectional rotation; when the rotary speed of the unidirectional rotary assembly is lower than that of the flywheel assembly, the unidirectional rotary assembly can disengage from the flywheel assembly to enable the flywheel assembly to idle for gyroscopic effect.

2. The AGSS as defined in claim 1, wherein the unidirectional rotary member is a ratchet having a ratchet disk and at least two pawls, the ratchet disk being connected with the sleeve in one piece, the two pawls being pivoted to the ratchet disk; the flywheel assembly comprises a flywheel having the axial hole, a recession and two dentations being formed at a side of the axial hole, the two dentations being recessed from the wall of the recession for inserting the two pawls.

3. The AGSS as defined in claim 1, wherein the unidirectional rotary member is a unidirectional bearing, unidirectionally rotatably sleeved onto the sleeve, and has its external periphery stopped against the wall of the axial hole.

4. The AGSS as defined in claim 1, wherein the transmission gear assembly comprises a base member, two first transmission gears, and two second transmission gears, the base member being connected with the spindle, each of the first transmission gears being rotatably mounted to the base member and engaging the external annular teeth of the sleeve, each of the second transmission gears being rotatably mounted to the base member and engaging the internal annular teeth of the wheel frame and one of the first transmission gears.
